(19) United States
(12) Patent Application Publication
(10) Pub. No.: US 2020/0058999 A1
(43) Pub. Date: Feb. 20, 2020

(54) METHOD AND ARRANGEMENT FOR AN ELLIPTICAL DIPOLE ANTENNA

(71) Applicant: TEKNOLOGIAN TUTKIMUSKESKUS VTT OY, Espoo (FI)

(72) Inventor: Antti LAMMINEN, VTT (FI)

(73) Assignee: Teknologian Tutkimuskeskus VTT Oy, Espoo (FI)

(21) Appl. No.: 16/344,595

(22) PCT Filed: Oct. 23, 2017
(86) PCT No.: PCT/FI2017/050732

§ 371 Date: Apr. 24, 2019

(30) Foreign Application Priority Data
Oct. 25, 2016 (FI) 20165803

(51) Int. Cl. H01Q 9/38; H01Q 1/48; H01Q 9/06; H01Q 9/28; H01Q 1/42; H01Q 1/22; H01Q 5/49

(52) U.S. Cl. CPC H01Q 9/38; H01Q 1/48; H01Q 9/065; H01Q 5/49; H01Q 1/422; H01Q 1/2291; H01Q 9/285

(57) ABSTRACT

A dipole antenna, comprising: a radiating element comprising two elliptical electrically conductive patterns arranged on a first plane, a ground plane element comprising a coupling aperture, the ground plane element arranged on a second plane spaced apart from the first plane, a feed element, said radiating element being electromagnetically coupled to the feed element via said via said coupling aperture in the ground plane element.

### BACKGROUND

The invention relates to a dipole antenna.

Traditional slot, dipole, patch and other types of printed antennas are commonly used in various applications ranging from microwave up to millimetre-wave length or even to terahertz-frequencies. They can be fabricated easily and with low cost.

A common downside is that known antennas usually have a narrow bandwidth and/or low antenna gain.

### BRIEF DESCRIPTION

Viewed from a first aspect, there can be provided a dipole antenna, comprising: a radiating element comprising two elliptical electrically conductive patterns arranged on a first plane, a ground plane element comprising a coupling aperture, the ground plane element arranged on a second plane spaced apart from the first plane, a feed element, said radiating element being electromagnetically coupled to the feed element via said coupling aperture in the ground plane element.

Thereby antennas providing wide bandwidth and high antenna gain may be achieved.

The antenna is characterised by what is stated in the characterising parts of the independent claim. Some other embodiments are characterised by what is stated in the other claims. Inventive embodiments are also disclosed in the specification and drawings of this patent application. The inventive content of the patent application may also be defined in other ways than defined in the following claims. The inventive content may also be formed of several separate inventions, especially if the invention is examined in the light of expressed or implicit sub-tasks or in view of obtained benefits or benefit groups. Some of the definitions contained in the following claims may then be unnecessary in view of the separate inventive ideas. Features of the different embodiments of the invention may, within the scope of the basic inventive idea, be applied to other embodiments.

In one embodiment, the ratio of the major axis to minor axis of the elliptical patterns is 1:1-2:1.

In one embodiment, the shape of the aperture is straight slot, H-shaped slot, bowtie slot or tapering slot.

In one embodiment, a feed element is arranged on a third plane spaced apart from the first and the second plane.

In one embodiment, the feed element comprises a microstrip line, a stripline, a substrate integrated waveguide, a coplanar waveguide (CPW), or a grounded coplanar waveguide (GCPW).

In one embodiment, the feed element comprises a coplanar waveguide arranged on the second plane.

In one embodiment, a dielectric antenna substrate layer is arranged between the radiating element and the ground plane, optionally comprising at least one cavity.

In one embodiment, a dielectric feed element substrate layer is arranged between the ground plane and the feed element, optionally comprising at least one cavity.

In one embodiment, a superstrate structure is arranged on the radiating element, optionally comprising at least one cavity.

In one embodiment, the antenna comprises at least one parasitic element electromagnetically coupled to the radiating element.

The new wideband aperture-coupled elliptical dipole antenna may comprise a feed element, a ground plane with coupling aperture and a radiating element that comprises elliptical dipole type conductive patterns.

The antenna may be air-filled or printed on a multi-layered substrate such as low temperature co-fired ceramic (LTCC), liquid-crystal polymer (LCP) or other printed circuit board materials.

The feed element can be, for example, a microstrip line, a (grounded) coplanar waveguide (CPW), a stripline, a substrate integrated waveguide (SIW) or other type of transmission line.

The separate feed element enables the antenna to be also used in antenna arrays wherein the feed network is isolated from the array elements.

The ground plane may act as an isolating surface between the feed element and the radiating element.

The coupling aperture arranged in the ground plane may be used for an electromagnetic field coupling from the feed element to the radiating element and vice versa.

The shape of the aperture can be, for example, a straight slot, an H-shaped slot, a bowtie-shaped slot, a tapering slot, or another type of slot.

The radiating element of the dipole antenna comprises two elliptical patterns made of electrically conductive material, such as metal, arranged on an antenna substrate layer. The thickness of the antenna substrate layer may be optimised for the frequency range and application of the antenna. The sizes of the ellipses may be chosen based on the desired frequency range. The major and minor axis of the ellipses may be optimised for the desired bandwidth and gain. In an embodiment, the major and minor axis are the same, resulting circular dipole elements.

The separation or distance between the elements may be optimised for desired input impedance.

One or more dielectric layer(s) or a superstrate(s), may be arranged on top of the radiating element. In addition, one or more parasitic radiating element(s) may be arranged on the superstrate layer(s) in order to increase gain and/or bandwidth.

Some parts of the substrate layer(s) may be removed in order to create an air cavity therein that decreases the effective permittivity for higher gain and wider bandwidth.

The antenna has many advantages. It may be easy and cheap to manufacture. The antenna may have a wide bandwidth and a high antenna gain. Wide bandwidth enables higher data rates in wireless communication, and also the use of one antenna covering multiple frequency bands instead of dedicated antennas for different frequency bands. This gives a high potentiality for lowering manufacturing and installation costs. Additionally, the antenna is easy to integrate in feeding networks and active components in antenna arrays.

### BRIEF DESCRIPTION OF FIGURES

Some embodiments illustrating the present disclosure are described in more detail in the attached drawings, in which

FIG. 1 is a schematic top view of a dipole antenna,

FIG. 2 is a schematic side view of the dipole antenna shown in FIG. 1 in partial cross-section,

FIG. 3 is a schematic top view of a detail of another embodiment of the dipole antenna,

FIG. 4 is a schematic top view of a detail of third embodiment of the dipole antenna,

FIG. 5 is a schematic top view of a detail of fourth embodiment of the dipole antenna,

FIG. 6 is a schematic side view of a dipole antenna in partial cross-section,

FIG. 7 is a schematic representation of comparison of properties of antenna arrangements, and

FIG. 8 is another schematic representation of comparison of properties of antenna arrangements.

In the figures, some embodiments are shown simplified for the sake of clarity. Similar parts are marked with the same reference numbers in the figures.

### DETAILED DESCRIPTION

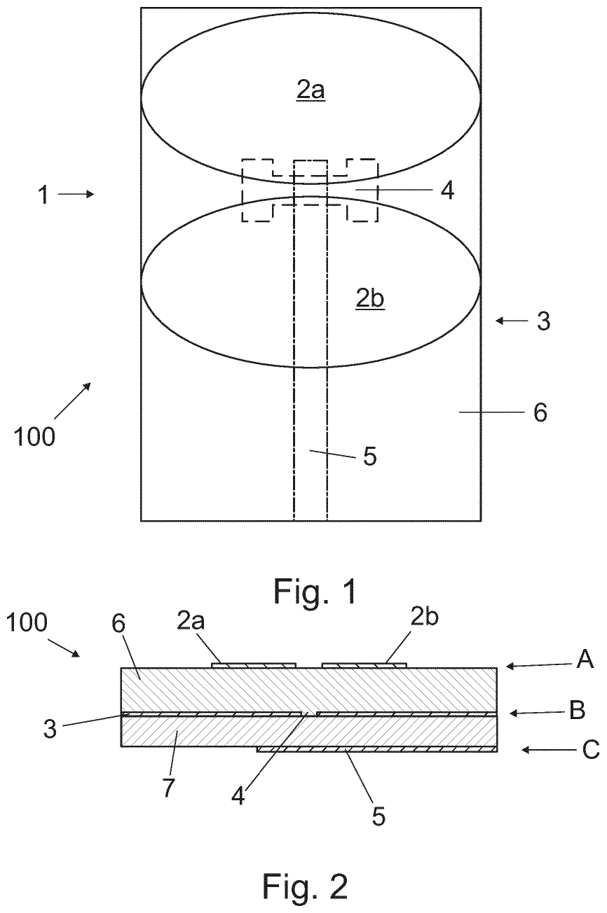

FIG. 1 is a schematic top view of a dipole antenna, and FIG. 2 is a schematic side view of the dipole antenna shown in FIG. 1 in partial cross-section.

The dipole antenna 100 comprises a radiating element 1 comprising two elliptical electrically conductive patterns 2a, 2b arranged on a first plane A of the dipole antenna.

The material of the electrically conductive patterns 2a, 2b may be e.g. metal, conductive plastic or conductive composite material. The first pattern 2a may have identical or different material compared to the material of the second pattern 2b.

In an embodiment, the two elliptical patterns 2a, 2b are equal in size and shape. An advantage is that a symmetrical radiation beam may be achieved.

In another embodiment, the two elliptical patterns 2a, 2b are diverse in their size and/or shape. An advantage is that a tailored radiation beam and/or impedance of the antenna may be achieved.

In an embodiment, the ratio of the major axis to minor axis of the elliptical patterns is selected in range of 1:1-2:1. Thus the elliptical pattern may be circle. In an embodiment, said ratio is 1.5:1.

Additionally, the dipole antenna 100 comprises a ground plane element 3 arranged on a second plane B spaced apart from the first plane A. The second plane B is preferably parallel to the first plane A. The distance of the first plane A and the second plane B is a design parameter of the antenna. According to an aspect, the distance is in range of 3% to 15% of the wavelength used. In an embodiment, the distance is 0.3 mm and said wavelength is 60 GHz.

The ground plane element 3 comprises electrically conductive material; it may be e.g. a metal layer. The ground plane element 3 has a coupling aperture 4, the shape of which is H-shaped slot in the shown embodiment (depicted by dashed line). The H-shaped slot may give a broad bandwidth.

The term “aperture” means that a certain part of the electrically conductive material of the ground plane element 3 has been removed or is missing.

In an embodiment, the coupling aperture 4 is construed of an air gap or any gasiform material.

In another embodiment, the coupling aperture 4 is construed of solid electrically non-conductive material.

The size of the ground plane element 3 is preferably somewhat larger than the size of the radiating element in order to minimize radiation to the backside of the ground plane.

A dielectric antenna substrate layer 6 is arranged between the radiating element 1 and the ground plane element 3. The antenna substrate layer 6 may be of fully solid material, or it may comprise at least one cavity (such as shown in FIG. 6), i.e. void volume, such as voids of a foamed material. An advantage is rather easy manufacturing.

In an embodiment, the at least one cavity constitutes practically all volume of the antenna substrate layer 6, while the radiating element is supported by thin support elements, such as screws, on the first plane A. An advantage is lower permittivity that may give broader bandwidth and/or higher antenna gain.

The dipole antenna 100 further comprises a feed element 5 depicted by dot-and-dash line. In the embodiment shown in FIG. 1, the feed element 5 is arranged on a third plane C spaced apart from the first A and the second plane B. According to an aspect, the distance is in range of 1% to 5% of the wavelength used. In an embodiment, the distance is 0.1 mm and said wavelength is 60 GHz.

In another embodiment, the third plane C is arranged between the first A and the second plane B. An advantage is that an alternative structure of the antenna may be provided.

The electrically conductive patterns 2a, 2b are coupled electromagnetically to the feed element 5 via the ground plane element 3.

In an embodiment, the feed element 5 comprises a microstrip line. An advantage is a simple and planar structure.

In an embodiment, the feed element 5 comprises a stripline. An advantage is that the structure is well protected and potentially causes less radiation in the surroundings.

In an embodiment, the feed element 5 comprises a substrate integrated waveguide. An advantage is that the structure is well protected, causes less radiation in the surroundings, and has a low attenuation per unit of length.

In an embodiment, the feed element 5 is another antenna. An advantage is that so called transmit array may be provided.

A dielectric feed element substrate layer 7 is arranged between the ground plane element 3 and the feed element 5. The feed element substrate layer 7 may be manufactured of fully solid material, or it may comprise at least one cavity, i.e. void volume, such as voids of a foamed material. An advantage is rather easy manufacturing, and lower attenuation per unit of length of the feed element.

In another embodiment, the at least one cavity constitutes practically all volume of the feed element substrate layer 7. An advantage is lower permittivity.

In an embodiment, the feed element 5 comprises a coplanar waveguide (CPW). The CPW comprises a single conducting track and a pair of return conductors, one to either side of the conducting track. The return conductors may serve as a ground plane element 3 of the radiating element 1, and the CWP may thus be arranged on the second plane B. In this embodiment, the feed element arranged on the third plane C is unnecessary and thus it may be omitted, as well as the feed element substrate layer 7. An advantage of the CPW is a simple and planar structure.

In a still another embodiment, the feed element 5 comprises a grounded coplanar waveguide (GCPW). This consists of CPW arranged on the second plane B and a ground plane element 3 arranged on the third plane C. An advantage is a simple and planar structure.

The dipole antenna 100 may be manufactured by e.g. multi-layer processes used for printed circuit board technology, or by any other manufacturing processes known per se.

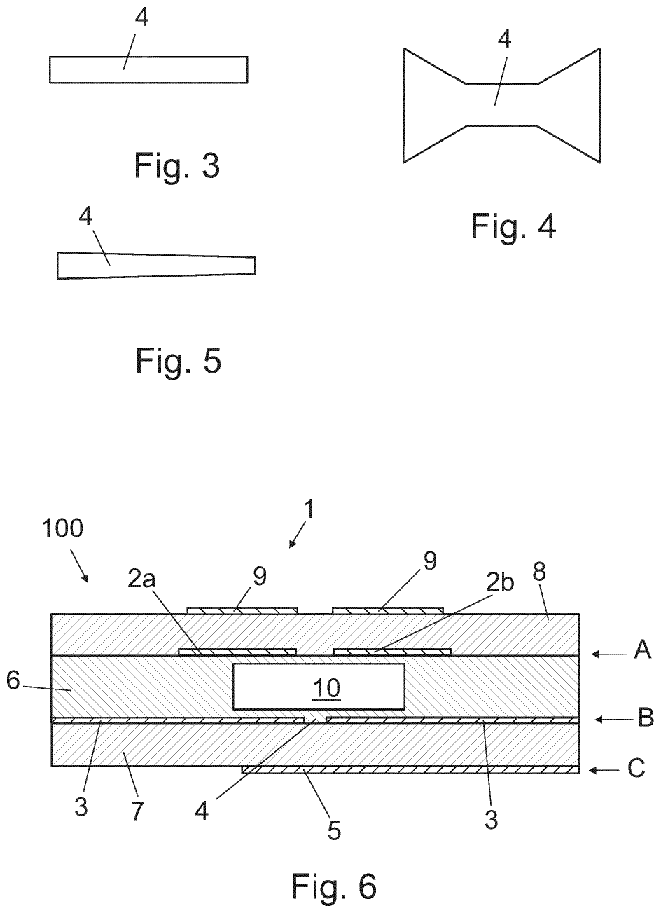

FIG. 3 is a schematic top view of a coupling aperture of another embodiment of the dipole antenna. The shape of the coupling aperture 4 is straight slot. An advantage is a simple structure.

FIG. 4 is a schematic top view of a coupling aperture of third embodiment of the dipole antenna. The shape of the coupling aperture 4 is bowtie slot. An advantage is a very broad bandwidth.

FIG. 5 is a schematic top view of a coupling aperture of fourth embodiment of the dipole antenna. The shape of the coupling aperture 4 is tapering slot. An advantage is a very broad bandwidth.

FIG. 6 is a schematic side view of a dipole antenna in partial cross-section. The embodiment shown in FIG. 6 is basically similar to that shown in FIGS. 1 and 2. However, the dipole antenna 100 comprises a superstrate structure 8 made of dielectric material and arranged on the radiating element 1.

The antenna substrate layer 6 and/or the feed element substrate layer 7 may comprise at least one cavity 7. Also he superstrate structure 8 may comprise at least one cavity that lowers the permittivity of the superstrate structure 8.

The superstrate structure 8 makes it possible to arrange at least one parasitic element 9 on the electrically conductive patterns 2a, 2b. The at least one parasitic element 9 is made of electrically conductive material and electromagnetically coupled to the radiating element 1.

An advantage of the parasitic element 9 is that the antenna gain of the dipole antenna 100 may be raised, or the size of the conductive patterns 2a, 2b may be reduced.

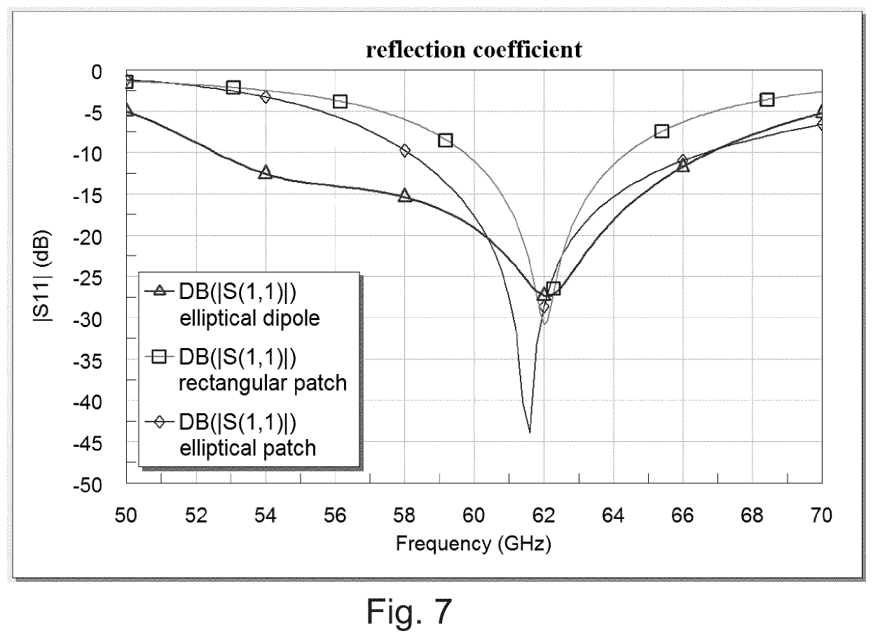

FIG. 7 is a schematic representation of comparison of reflection coefficient (S11) of a dipole antenna 100 according to the invention (Δ) and two known antenna types, i.e. a rectangular patch antenna (□) and an elliptical patch antenna (⋄).

As one can immediately noticed, the reflection coefficient of the dipole antenna is lower than −10 dB between 52 GHz and 66 GHz showing much wider impedance bandwidth than the patch antennas.

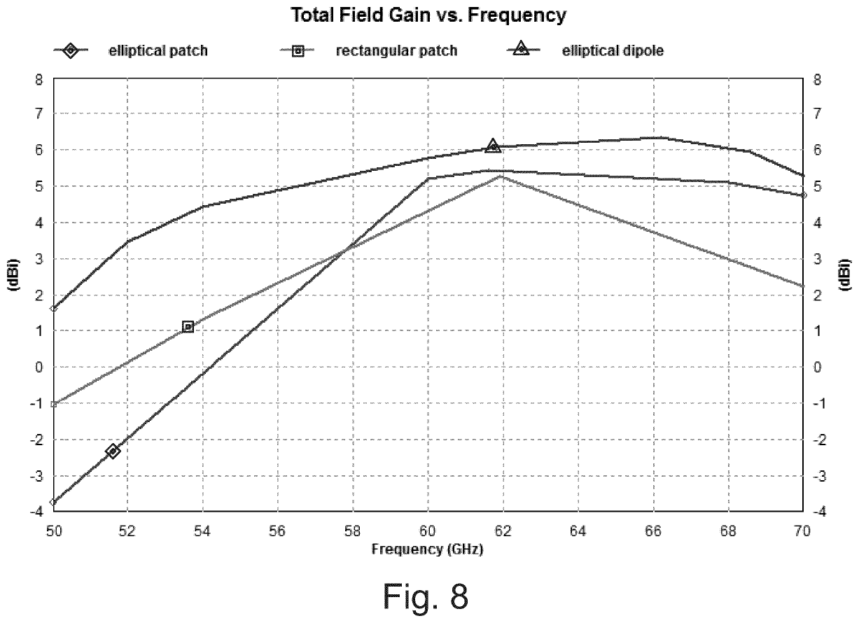

FIG. 8 is another schematic representation of comparison of total field gain of a dipole antenna 100 according to the invention (Δ) and two known antenna types, i.e. a rectangular patch antenna (□) and an elliptical patch antenna (⋄).

As one can immediately noticed, the antenna gain of the dipole antenna is higher than 3.5 dBi from 52 GHz at least up to 70 GHz showing much wider radiation bandwidth than the patch antennas.

The invention is not limited solely to the embodiments described above, but instead many variations are possible within the scope of the inventive concept defined by the claims below. Within the scope of the inventive concept the attributes of different embodiments and applications can be used in conjunction with or replace the attributes of another embodiment or application.

The drawings and the related description are only intended to illustrate the idea of the invention. The invention may vary in detail within the scope of the inventive idea defined in the following claims.

### REFERENCE SYMBOLS

1 radiating element

2a, b electrically conductive pattern

3 ground plane element

4 coupling aperture

5 feed element

6 antenna substrate layer

7 feed element substrate layer

8 superstrate structure

9 parasitic element

10 cavity

100 dipole antenna

A 1^{st} plane

B 2^{nd} plane

C 3^{rd} plane

1. A dipole antenna, comprising:
a radiating element comprising two elliptical electrically conductive patterns arranged on a first plane
a ground plane element comprising a coupling aperture, the ground plane element arranged on a second plane spaced apart from the first plane
a feed element
said radiating element being electromagnetically coupled to the feed element via said coupling aperture in the ground plane element.

2. The dipole antenna as claimed in claim 1, wherein the ratio of the major axis to minor axis of the elliptical patterns are 1:1-2:1.

3. The dipole antenna as claimed in claim 1, wherein the shape of the aperture is straight slot, H-shaped slot, bowtie slot or tapering slot.

4. The dipole antenna as claimed in claim 1, wherein a feed element is arranged on a third plane spaced apart from the first and the second plane.

5. The dipole antenna as claimed in claim 4, wherein the feed element comprises a microstrip line, a stripline, an antenna, a substrate integrated waveguide, a coplanar waveguide (CPW), or a grounded coplanar waveguide (GCPW).

6. The dipole antenna as claimed in claim 1, wherein the feed element comprises a coplanar waveguide arranged on the second plane.

7. The dipole antenna as claimed in claim 1, wherein a dielectric antenna substrate layer is arranged between the radiating element and the ground plane, optionally comprising at least one cavity.

8. The dipole antenna as claimed in claim 1, wherein a dielectric feed element substrate layer is arranged between the ground plane and the feed element, optionally comprising at least one cavity.

9. The dipole antenna as claimed in claim 1, wherein a superstrate structure is arranged on the radiating element, optionally comprising at least one cavity.

10. The dipole antenna as claimed in claim 1, wherein it comprises at least one parasitic element electromagnetically coupled to the radiating element.
